(19) United States
(12) Patent Application Publication
(10) Pub. No.: US 2004/0205456 A1
(43) Pub. Date: Oct. 14, 2004

(54) System and process for reporting new business production

(76) Inventors: Robert Hammock, Lynchburg, VA (US); Laura Webber, Lynchburg, VA (US); Mike Ludwig, Lynchburg, VA (US); Janet Johnson, Forest, VA (US); Rob Miller, Forest, VA (US)

Correspondence Address: Jonathan D. Link, Hunton & Williams, Suite 1200, 1900 K Street, N.W., Washington, DC, 20006, US

(21) Appl. No.: 09/994,594

(22) Filed: Nov. 26, 2001

(51) Int. Cl. G06F 15/00; G06F 17/21

(52) U.S. Cl. 715/500; 705/4

(57) ABSTRACT

A system and process is provided for reporting new business production. Information from a plurality of sources related to new business production of related products, such as insurance, is gathered in a central location. A standard format for the information is provided. The information is provided from the central location to one or more users. The reporting capabilities to ensure that information about new business for varying products, such as insurance, is provided in a standardized manner.

### FIELD OF THE INVENTION

The present invention relates to a system and process for reporting new business production, and more particularly to a system and process for gathering information related to new business production in a central location and providing reporting capabilities to ensure that information about new business for varying products, such as insurance products, is provided in a standardized manner.

### BACKGROUND OF THE INVENTION

Many types of information are often gathered in a central location to provide more ready access by others. Information is received from a variety of sources, and gathered at a central location, such as data warehouse. In the electronic age, information is often transmitted from a location over a network to a data warehouse architecture, such as a database or other warehouse structure.

One drawback with current systems is that information from various sources may be received in various formats and with different types of and/or categories of information. Gathering and processing information in different formats may be difficult, resulting in increased storage requirements, processing time, and expense. Further, information about different types of products may contain different content.

By way of example, in the context of insurance products, information related to a automobile insurance policy may be different than information related to a life insurance policy, yet an insurer may offer both products, and an insurance agent sell both products to consumers. Further, both an insurer and an insurance agent (such as within an insurance agency), may desire to gather and process the information related to sale of the products, both individually and in the aggregate. For example, new business production from an individual agent, a group of agents, a region or other combinations may be desirable. However, varying formats may greatly complicate obtaining such information.

Other drawbacks may also exist.

### SUMMARY OF THE INVENTION

It is therefore desirable that the invention overcome these and other drawbacks of present systems and methods.

An aspect of the present invention is to provide reports regarding information received from a plurality of sources.

It may also be desirable to have a process and system generating reports related to new business production at a plurality of production sources located geographically apart from each other. Therefore, a process for generating such reports is provided comprising the steps of: receiving a request to generate at least one report related to new business production for at least one of the plurality of production sources; receiving at least one selection parameter related to the at least one requested report, where the at least one selection parameter defines a portion of the information to be contained within the at least one report, and where the information has been received from the plurality of production sources; processing the at least one selection parameter, where the processing includes obtaining the portion of the information and formatting the at least one report; and generating the at least one report based on the processed selection parameters.

Another aspect of the invention is a process for generating new business reports comprising the steps of: receiving a request to generate at least one report related to new business production for at least one of the plurality of production sources; receiving at least one selection parameter related to the at least one requested report, where the at least one selection parameter defines a portion of the information to be contained within the at least one report, and where the information has been received from the plurality of production sources; processing the at least one selection parameter, where processing includes: a) obtaining the portion of the information; b) formatting the at least one report, including arranging contents of the report into an appropriate presentation format; and c) converting the report into one or more application formats for viewing; and generating the at least one report based on the processed selection parameters.

A further aspect of the invention may be a system for generating new business reports comprising: means for receiving a request to generate at least one report related to new business production for at least one of the plurality of production sources; means for receiving at least one selection parameter related to the at least one requested report, where the at least one selection parameter defines a portion of the information to be contained within the at least one report, and where the information has been received from the plurality of production sources; means for processing the at least one selection parameter, where the processing includes obtaining the portion of the information and formatting the at least one report; and means for generating the at least one report based on the processed selection parameters.

It may also be desirable that a system for generating new business reports comprise: means for receiving a request to generate at least one report related to new business production for at least one of the plurality of production sources; means for receiving at least one selection parameter related to the at least one requested report, where the at least one selection parameter defines a portion of the information to be contained within the at least one report, and where the information has been received from the plurality of production sources; means for processing the at least one selection parameter, where processing includes: a) obtaining the portion of the information; b) formatting the at least one report, including arranging contents of the report into an appropriate presentation format; and c) converting the report into one or more application formats for viewing; and means for generating the at least one report based on the processed selection parameters.

Another aspect of the invention may be a medium storing code for causing a processor to generate new business reports, where the medium comprises: code for causing a processor to receive a request to generate at least one report related to new business production for at least one of the plurality of production sources; code for causing a processor to receive at least one selection parameter related to the at least one requested report, where the at least one selection parameter defines a portion of the information to be contained within the at least one report, and where the information has been received from the plurality of production sources; code for causing a processor to process the at least one selection parameter, where the processing includes obtaining the portion of the information and formatting the at least one report; and code for causing a processor to generate the at least one report based on the processed selection parameters.

A further aspect of the invention may be a medium storing code for causing a processor to generate new business reports comprising: code for causing a processor to receive a request to generate at least one report related to new business production for at least one of the plurality of production sources; code for causing a processor to receive at least one selection parameter related to the at least one requested report, where the at least one selection parameter defines a portion of the information to be contained within the at least one report, and where the information has been received from the plurality of production sources; code for causing a processor to process the at least one selection parameter, where processing includes: a) obtaining the portion of the information; b) formatting the at least one report, including arranging contents of the report into an appropriate presentation format; and c) converting the report into one or more application formats for viewing; and code for causing a processor to generate the at least one report based on the processed selection parameters.

Additionally, it may also be desirable to gather and process information regarding insurance products received from a variety of sources.

The accompanying drawings, which are incorporated in and constitute a part of this specification, illustrate an embodiment of the invention and, together with the description, serve to explain the principles of the invention.

### BRIEF DESCRIPTION OF THE DRAWINGS

FIG. 1 is a flowchart illustrating a process for a new business production reporting system according to an embodiment of the invention.

FIG. 2 is graphic user interface for a new business production reporting system according to an embodiment of the invention.

FIG. 3 is a graphic user interface illustrating a selection of details for a new business production reporting system according to an embodiment of the invention.

FIG. 4 is a graphic user interface illustrating a selection of report parameters according to an embodiment of the invention.

FIG. 5 illustrates a report according to an embodiment of the invention.

FIG. 6 is a schematic representation of a system for implementing one or more of the processes described according to embodiments of the invention.

### DETAILED DESCRIPTION OF THE INVENTION

Reference will now be made in detail to the present preferred embodiment of the invention, an example of which is illustrated in the accompanying drawings in which like reference characters refer to corresponding elements.

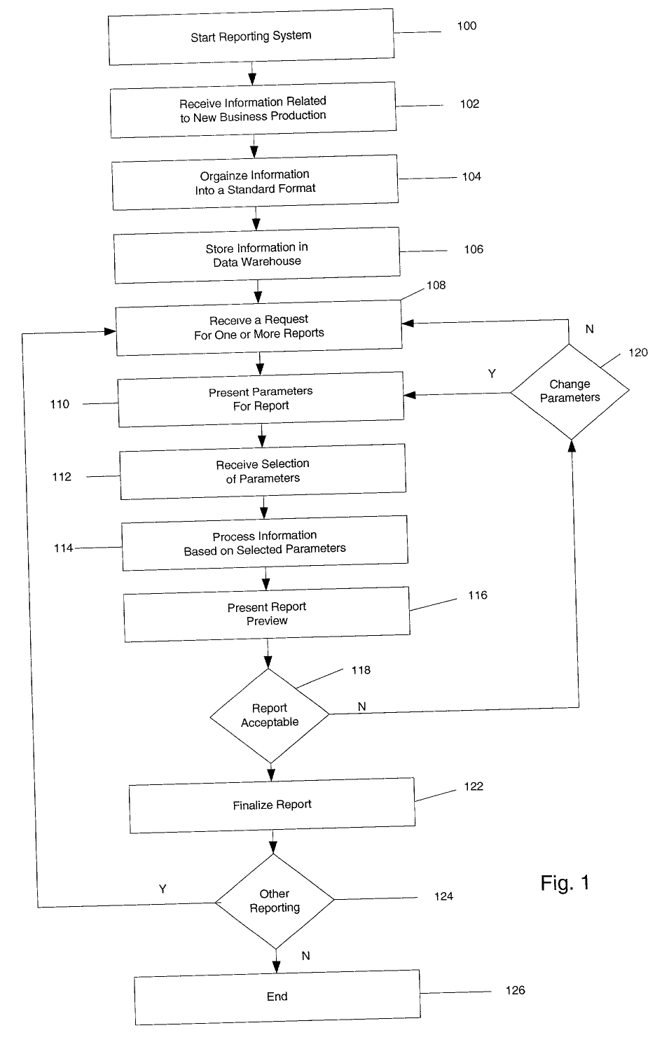

FIG. 1 is a flowchart illustrating a process for a new business production reporting system according to an embodiment of the invention. At step 100, a process for a new business reporting system may be started. According to an embodiment of the invention, a process may be started at step 100 by a user, such as by activating a icon or button at a processor terminal, such as with a mouse, keyboard, key pad, touch screen, or other activation device.

At step 102, a new business reporting system receives information related to new business production. According to an embodiment of the invention, information received may include relevant information about the new business production, including, but not limited to, who sold the product, when the product was sold, where the product was sold, the identity of the product, characteristics of the purchaser and characteristics of the product. Information is received from production sources, which may include, but are not limited to, one or more insurance agents, one or more insurance agencies, one or more financial service agents (e.g., broker, bank representative, etc.), one or more financial service agencies, and/or combinations thereof. According to an embodiment of the invention, production sources may be grouped as teams for evaluation and informational purposes. By way of example, for a new business production system related to insurance products, information may include, but is not limited to, the type of insurance product, information about the purchaser (e.g., name, address, age, gender, income, etc.), information about the seller (e.g., agency, agent name, location), date of sale, amount of policy, and amount of premiums. Other types of information may also be received. Further, according to an embodiment of the invention, information may be received from one or more sources, located in one of more geographic locations or areas.

At step 104, information received is organized into a stand format. According to an embodiment of the invention, information may be received in a plurality of presentation formats and application. This may be due to receiving information from a plurality of sources (e.g., different insurance agencies) as well as receiving information about a plurality of different products having different informational content (e.g., different insurance policies). Presentation formats may include, but is not limited to, tables, pie charts, bar graphs, text, and/or any combination thereof.

At step 106, information is stored with a data warehouse. According to an embodiment of the invention, a data warehouse may be any data storage device, including a plurality of storage devices. Information may be organized and stored in a database or other data storage vehicle. Other manners of storing data may also be used.

A request for one or more reports is received at step 108. According to an embodiment of the invention, a request may be made by a user at a terminal, such as, but not limited to, a computer, a personal computer, a processor terminal, and a network terminal. A report may be requested through the processor, such as by a user entering information regarding the type(s) of report(s) requested. By way of example, a user may enter information in a graphic user interface, as described below. Requests may be transmitted over a network and received at a system of the present invention. Other manners for receiving requests may also be used.

At step 110, a parameter selections are presented. According to an embodiment of the invention, parameter selections presented to a user may based on the report(s) selected at step 108. Parameter selections may comprise selecting any parameters related to information to be included within the desired report. Parameters may include, but are not limited to, a team(s) for which information is requested, an agent(s) for which information is request, an agency or agencies for which information is requested, a location(s) of a team(s), agent(s), and/or agencies, a start date for the information contained within the report, an end date for the information contained within the report, and the product type(s) of information. Other parameters may also be used. By way of example, in a report regarding new business production for a month, parameter selections may include the start and end dates of the month (e.g., the first and last day of the month), and the teams for which production information is desired. Other manners for providing parameters selections may also be used.

One or more parameter selections are received at step 112. According to an embodiment of the invention, as described above, a user selects parameters (e.g., enter selection(s) in a graphic user interface) and transmit the selections to a new business production reporting system of the present invention. Transmitting and receiving selections may be accomplished over a network (e.g., the Internet, an intranet, a WAN, a LAN, etc.), and may include using a transmitter and receiver, such as known modems or other data transmitters and receivers.

At step 114, information is processed based on selected parameters. According to an embodiment of the invention, a report may be generated based on the selected parameters received. Processing information may include, but is not limited to, gathering information based on the selected parameters, arranging the information in one or more appropriate presentations (e.g., bar graph, chart, text, pie chart, etc.), and converting the report to one or more appropriate application format(s) (e.g., Word, WordPerfect, Adobe, Excel, HTML, etc.) Other processing may also be performed.

At step 116, a report preview is presented. According to one embodiment of the invention, a report preview may be presented to a user, such as through a processor having a monitor, to enable the user to determine if the appropriate information is presented in the report. The user determines if the report is acceptable at step 118. If the report is not acceptable, the user determines if selection parameters are to be changed at step 120. According to an embodiment of the invention, a user may determine if selection parameters need to be changed, or if a new report type needs to be selected. If selection parameters are to be changed, parameter selections are presented at step 110. If selection parameters are not to be changed, a request for one or more reports is presented at step 108.

If the report is acceptable, the report is finalized at step 122. Finalizing a report may include, but is not limited to, presenting the report to one or more users (e.g., presenting the report(s) to a user at a processor, providing access to the report(s) via an HTML web page available for access over a network, etc.) by a transmitting a report to a user (e.g., email message with attachment, etc.), and saving the report(s) for later access. Other manners of formalizing a report may also be performed.

At step 124, an option to generate other reports is presented. If one or more additional reports are desired, a request for one or more reports is presented at step 108. If no other report(s) are desired, the process ends at step 126. While the process according to an embodiment of the invention has been described above with regard to certain steps occurring in a specified order, it is understood that such a process may be performed with one or more steps removed, one or more steps added, one or more steps performed in a different sequence, or a combination thereof, without departing from the scope of the present invention.

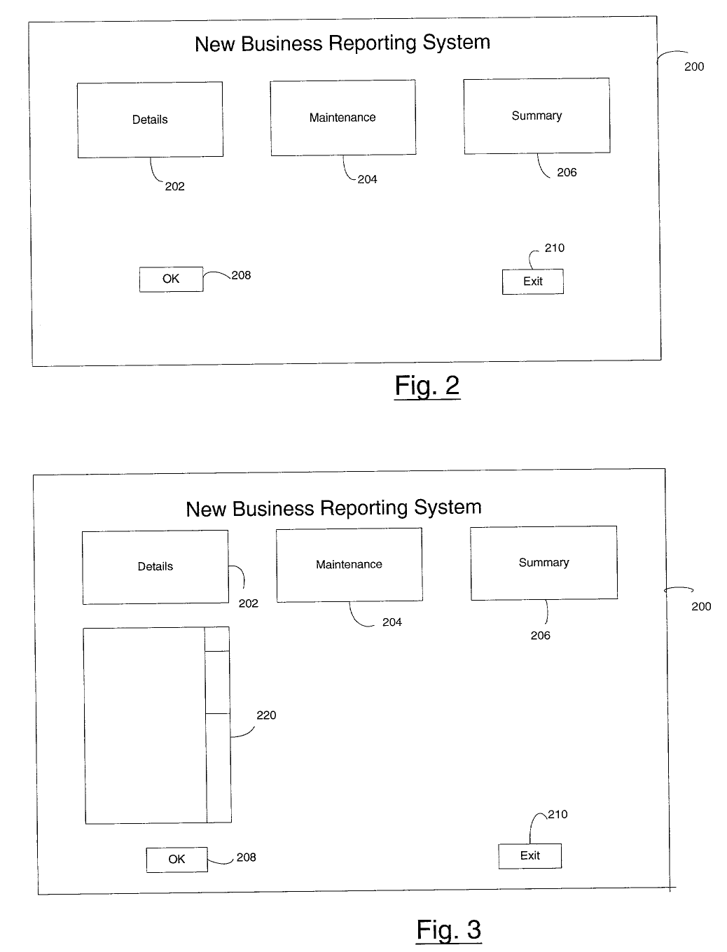

FIG. 2 is graphic user interface 200 for a new business production reporting system according to an embodiment of the invention. A user may interact with graphic user interface 200 to access one ore more functions of the present invention. According to an embodiment of the invention, a user may access a Details function button 202, a Maintenance function button 204, and a Summary function button 206. Detail function button 202 may provide access to reports providing details of information within a data warehouse architecture. Maintenance function button 204 may provide access to reports providing information on maintenance of the data warehouse architecture. Summary function button 206 may provide access to reports providing summarized or aggregated information. Further, a user may activate an OK function button 208 and/or an Exit function button 210. According to an embodiment of the invention, a function button may enable a user to access reports related to a particular function. These functions will now be described in greater detail below. Other functions may also be also be available with the present invention.

Activating a function button may provide access to one or more subfunctions. According to an embodiment of the invention, subfunctions may be present in a drop down menu. By way of example, after a user activates Detail function button 202, drop down menu 220 in graphic user interface 200 may provide access to one or more reports, as illustrated in FIG. 3. Detail reports may include awaiting APS (Attending Physicians Statement) by Characters, awaiting APS by individual GAN (General Agent Number), awaiting APS by Office, awaiting APS by team identification, awaiting APS by team name, awaiting paramed and laboratories by individual, and awaiting paramed and laboratories by office. These reports may provide details of information and products, such as insurance policies and information related thereto. Maintenance reports may include policies entered with invalid dates. Summary reports may include cycle time reports, and total counts of final actions (placing policy inforce, setting the policy as Not Taken (insured does not accept policy)). Additional report types and definitions of operational fields are described in greater detail below.

A user may select one or more reports from drop down menu 220 in graphic user interface. Upon selecting the report(s), a user may activate OK function button 208 to activate the new business production reporting system. Selecting a report and activating the OK function button 208 (or any other function button) may be performed in any manner, such as through use of a mouse, a keyboard, a laser pointer, or other manner of selection. Exit function button 210 may enable a user to exit a new business production reporting system according to an embodiment of the invention.

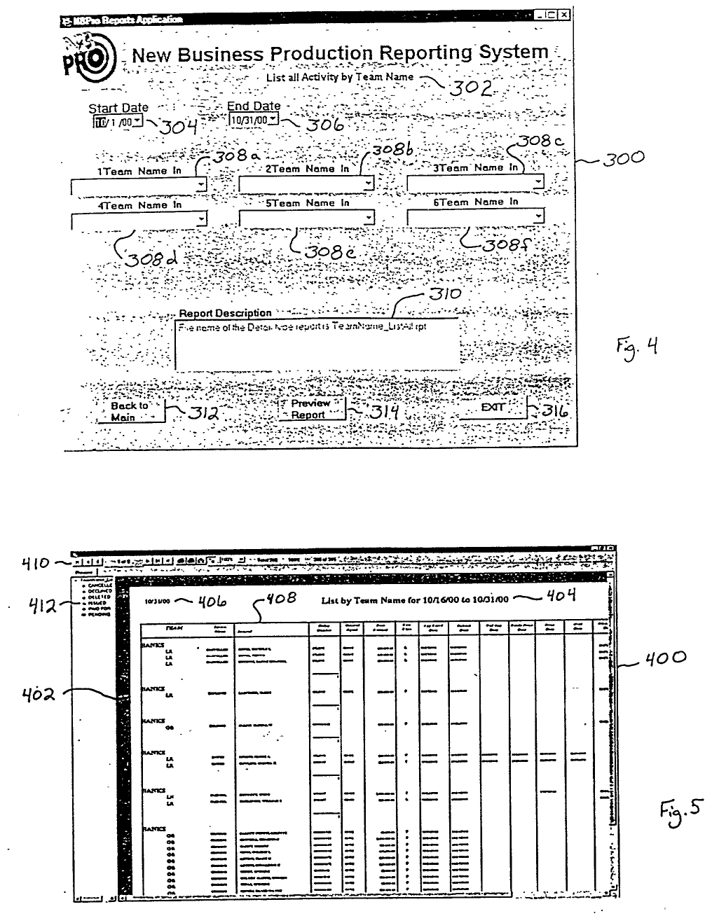

According to an embodiment of the invention, upon activating a selected report, a graphic user interface 300 may be present to a user for selecting report parameters. As illustrated in FIG. 4, graphic user interface 300 may include a title bar 302 which may identifies the report selected by the user. By way of the example illustrated in FIG. 4, title bar 302 may read “List all Activity by Team Name,” as selected by the user. While graphic user interface 300 of FIG. 4 illustrates a presentation for selecting parameters associated with a report for listing activity by team name, it is understood that other parameters may also be presented, and that other reports may require that different parameters be selected by a user. Start Date drop down menu 304 may enable a user to designate a start date for the report information, and End Date drop menu 306 may enable a user to designate an end date for the report information.

Team drop down menus 308a-f may enable a user to select team names for inclusion within the report. Although the example provided in FIG. 4 enables a user to select up to six teams to include within the report, any number of teams may be designated to include in a report. Report description window 310 enables a user to provide a description of the report, as well as provide a file name for saving the report to a data storage module. Control buttons within graphic user interface 300 may enable a user to navigate within a new business production reporting system. According to an embodiment of the invention, Back to Menu function button 312 may enable a user to navigate back to graphic user interface 200 of FIG. 1. Activating Back to Menu function button 312 may be performed at any time during the manipulation of buttons within graphic user interface 300. Preview Report function button 314 may enable a user to preview a report based on the report and parameters selected. According to an embodiment of the invention, after previewing the report, a user may elect to return to graphic user interface 200 to select a different report, such as, for example, if the initially selected report does not provide the information desired by the user. Exit function button 316 may enable a user to exit a new business production reporting system according to an embodiment of the invention.

FIG. 5 illustrates a graphic user interface 400 displaying a report according to an embodiment of the invention. Continuing with the example above, report 402 is displayed based on user selects parameters. Report 402 may include a title area 404, such as, by way of the present example, “List by Team Name for Oct. 16, 2000 to Oct. 31, 2000.” Date area 406 may provide the date the report was run, such as, for example, “Oct. 31, 2000.” Report 402 may also contain information 408 presented to the user. In the example illustrated in FIG. 5, information 408 is presented in the form of a chart, with various teams named, system status, insured, policy number, general agent number, face amount, and other information. Navigation toolbar 410 enables a user to move within a report (e.g., from one page to another) and between reports. Navigation tree 412 may prove a user information about where in a report a user is, thereby easing the process of navigating through a report.

As described above, various reports may be used in connection with one or more embodiments of the present invention. By way of example, reports may include a list of all agent numbers, motor vehicle reports from one or more entities (e.g., insurance companies) full details of bill validation, details of non-paid of bill validation, a summary of bill validation, policies cancelled and not taken out by a writing agent, a list of all case managers, a channel for all pending settlements, a channel awaiting an attending physician statement (“APS”) with channel description, a channel awaiting APS, a channel awaiting paramed labs with a channel description certified, a channel awaiting paramed labs with channel description, channel awaiting paramed labs, channel counts, channel cycle time, channel in-force premium, a channel in settlement, a list of all channels, a channel pending breakdown, a channel pending over X days (where X is a natural number), a channel placement ratio for a particular year (e.g., 1999, 2000, 2001, etc.), a channel reissue percent, a description of a channel awaiting parameds, a description of a channel issues, a copy of weekly submit counts for finance, corporate monthly overall team production premiums, corporate monthly term product premium by channel, corporate monthly term product by general agent, corporate monthly term by product, corporate monthly universal life insurance product (“UL”) preferance rate new business cycle time, corporate monthly UL preference underwriter turnaround, corporate monthly UL standard underwriter turnaround, corporate monthly UL standard rate new business cycle-time, corporate monthly UL submitted large case premium, corporate monthly UL submitted premium, corporate pending settlement count, corporate submitted annual team large case premium, corporate submitted term annual premium, corporate term cycle-time for preference cases, corporate term cycle-time for standard cases, corporate term UWTurnaround preferred, corporate term underwriter turnaround standard, cycle time detail by office, and detail drill down team cycle-time.

Other reports may include final disposal ratios, future dated application record dates, GA of all pending settlements, GA of awaiting APS, GA of issue to mail cycle-time, GA of list of all paid for policies, GA of list of all submitted policies, GA of list of issues, GA of mail to in-force cycle-time, GA of record to submit cycle-time, GA of record to under appropriate cycle-time, GA of receipt to issue cycle-time, GA of signed to in-force cycle-time, GA of signed to in-force cycle-time, GA of signed to record cycle time, GA for submission to underwriter cycle time, large case settlements, large case submissions, last request received X days ago (where X is a natural number), a list of all pending trial cases and settlement by GA, a list of issues by GA, a list of reissues and reasons by customer group, list of reissues and reasons, a list of pending trial cases, a list of reopens, a list of underwriter approvals with rate class, mailed by GA number, mailed cases sorted by plan and team, mailed cases sorted by team, multiple hosts, NIGO cycle time, not taken out (“NTO”) declarations and cancellations by GA number, NTO declarations and cancellations by GA number, NTO declarations and cancellations by plan code and team, NTO declarations and cancellations by plan code, NTO declined and cancelled by team, null status service level agreement (“SLA”) cases from one or more entities (e.g., insurance company), NY replacement cases, office cycle-times summary, office detailed cycle-time, office total IGO cycle-time, office total cycle-time for application not received in good order, office awaiting APS, office awaiting paramed labs, office awaiting parameds, office counts, office cycle-times summary, office cycle-time, office cycle-time, office cycle-time, office enforce premium, office in settlement, office pending breakdown, office pending over X days (e.g., where X is a natural number), office placement ratio for a particular year (e.g., 1999, 2000, 2001, etc.), office reissue percent, paid for by GA number, paid for by team identification with plan codes, paramed labs outstanding, pending with quote and reopen, pending breakdown by GA number, pending breakdown by office and team, pending cases sorted by agent number, percent submits by face amount, percent submits by face for teams, plan code submitted by GA number, plan codes issued by GA number, plan codes paid for by GA number, policy exception report, and reissue reasons report.

Reports may also include settlement files over a particular age (e.g., forty-five days old), SLA Cases with a particular status, submissions by channel description, submissions by GA number, submissions by team identification with plan codes, sub-report submissions, sub-report final disposal, sub-report issues, sub-report mailed, sub-report pending, team and plan all pending settlement, team all pending settlement, team APS ordered over X days from paramed record (where X is a natural number), team awaiting APS, team awaiting paramed labs, team awaiting parameds, team counts, team cycle-times summary, team cycle-time, team enforce premium, team in settlement, team list all declaration, cancellation and NTO, team list all issued policies, team list all mailed policies, team list all submitted policies, team list all, team medical insurance bureau (“MIB”) authorizations ordered over X days ago (where X is a natural number), team pending breakdown with quote and reopen, team pending with quote and reopen, team pending breakdown, team pending over X days (where X is a natural number), team pending with quote and reopen, team placement ratio for a particular year (e.g., 1999, 2000, 2001, etc.), team reissue percent, team name awaiting APS, team name awaiting paramed labs, team name awaiting parameds, team name counts, team name cycle-time, team name in-force premium, team name in settlement, team name list all, team name pending breakdown, team name pending over X days (where X is a natural number), team name placement ratio for a particular year (e.g., 1999, 2000, 2001, etc.), team name reissue percent, total count sub-reports excluding a particular entity (e.g., an insurance company), total counts excluding a particular entity, total cycle-times excluding a particular entity, total issues excluding a particular entity, total mailed cases excluding a particular entity, total NTO, declared and cancelled, excluding AML, total paid for cases excluding AML, total submits excluding AML, trial cycle-time, trials pending breakdown and total pending, trials total counts, trials with quotes over X days (where X is a natural number), underwriter pending list and count, underwriter awaiting APS, underwriter awaiting paramed, underwriter awaiting parameds labs, underwriter cancelled, not taken or declined, underwriter issued, underwriter issue to mail cycle-time.crf, underwriter issue to mail cycle-time, underwriter issue to mail cycle-time, a list of all underwriters, underwriter mail to in-force cycle-time, underwriter mailed, underwriters paid for, underwriter record to issue cycle-time, underwriter record to submit cycle-time, underwriter record to undappr cycle-time, underwriter receipt to submit cycle-time, underwriter signed to in-force cycle-time, underwriter signed to record cycle-time, underwriter submit to undappr to cycle-time, underwriter submits, underwriter undappr to issue cycle-time, and weekly submit counts for finance, year to date paid SLA bonuses. Other reports may also be used.

According to an embodiment of the invention, reports regarding Breakdown Total Pending based on Case Age by Office” may provide the number of cases in each age category, i.e. 1-30 days old, 31-45 days old, etc. Age may be based on current system date minus the application-received date. Reports regarding “Breakdown Total Pending based on Case Age by Team Identification” may provide the number of cases in each age category, i.e. 1-30 days old, 31-45 days old, etc. Age may be based on current system date minus the application-received date. Reports regarding “Breakdown Total Pending based on Case Age by Team Name” may provide a the number of cases in each age category, i.e. 1-30 days old, 31-45 days old, etc. Age may be based on current system date minus the application-received date. Reports regarding “Cases with Labs Awaiting Parameds by Channel” may list all cases where the labs are received, but the paramed is still outstanding for a certain channel specified by the user. Reports regarding “Cases with Labs Awaiting Parameds by Individual GA” may provide lists all cases where the labs are receipted, but the paramed is still outstanding for a certain GA number specified by the user.

According to an embodiment of the invention, reports regarding “Cases with Labs Awaiting Parameds by Office” may provide lists of all cases, by office, where the labs are receipted, but the paramed is still outstanding. Reports regarding “Cases with Labs Awaiting Parameds by Team ID” may provide lists of all cases where the labs are receipted, but the paramed is still outstanding for a certain team ID specified by the user. Reports regarding “Cases with Labs Awaiting Parameds by Team Name” may provide lists of all cases where the labs are receipted, but the paramed is still outstanding for a certain team name specified by the user. Reports regarding “List of All Activity by Case Manager” may provide lists all pending activity for a certain date range and case manager(s) specified by the user. The report may further list activity for all cases that have a submit date that falls within the date range chosen by the user. Details on the report may include rate class, GA number, submit date, case age, cycle time, and issue dates. Cycle-time may measured by the application receipt date to mail date. Reports regarding “List of All Activity by Channel” may provide lists of all pending activity for a certain date range and channel specified by the user. The report may list activity for all cases that have a submit date that falls within the date range chosen by the user. Details on the report may include rate class, GA number, submit date, case age, cycle time, and issue dates. Cycle-time may be measured by the application receipt date to the mail date.

According to an embodiment of the invention, reports regarding “List of All Activity by Team ID” may provide lists of all pending activity for a certain date range and team ID specified by the user. The report may list activity for all cases that have a submit date that falls within the date range chosen by the user. Details on the report may include rate class, GA number, submit date, case age, cycle-time, and issue dates. Cycle-time may be measured by the application receipt date to the mail date. Reports regarding “List of All Activity by Underwriter” may provide lists of all pending activity for a certain date range and underwriter specified by the user. The report may list activity for all cases that have a submit date that falls within the date range chosen by the user. Details on the report may include rate class, GA number, submit date, case age, cycle time, and issue dates. Cycle-time may be measured by the application receipt date to the mail date. Reports regarding “Pending Cases over X Days by Channel” may provide lists of pending cases over a certain age specified by the user. Age may be based on the current system date minus the date the application was received. Reports regarding “Pending Cases over X Days by Individual GA” may provide lists of pending cases over a certain age specified by the user. Age may be based on current system date minus the application-received date. Reports regarding “Pending Cases over X Days by Office” may provide lists of pending cases over a certain age specified by the user. Age may be based on current system date minus the date the application was received. Reports regarding “Pending Cases over X Days by Team Identification” may provide lists of pending cases over a certain age specified by the user. Age may be based on current system date minus the application-received date. Reports regarding “Pending Cases over X Days by Team Name” may provide lists of pending cases over a certain age specified by the user. Age may be based on current system date minus the application-received date.

According to an embodiment of the invention, reports regarding “Placement Ratio Counts by Channel” may provide a count of paid-for, cancelled, declined, and not-taken policies in a date range specified by the user and gives the placement ratio for those policies. The report may use the final disposition date for selection. Reports regarding “Placement Ratio Counts by Individual GA” may provide a count of paid-for, cancelled, declined, and not-taken policies in a date range specified by the user and gives the placement ratio for those policies. The report may use the final disposition date for selection. Reports regarding “Placement Ratio Counts by Office” may provide a count of paid-for, cancelled, declined, and not-taken policies in a date range specified by the user and gives the placement ratio for those policies. The report may use the final disposition date for selection. Reports regarding “Placement Ratio Counts by Team Identification” may provide a count of paid-for, cancelled, declined, and not-taken policies in a date range specified by the user and gives the placement ratio for those policies. The report may use the final disposition date for selection. Reports regarding “Placement Ratio Counts by Team Name” may provide a count of paid-for, cancelled, declined, and not-taken policies in a date range specified by the user and gives the placement ratio for those policies. The report may use the final disposition date for selection. Reports regarding “Premium In-force for a Date Range by Channel” may provide the total in-force premium for a specified channel and is determined by paid-for dates that fall in the date range specified by the user. Reports regarding “Premium In-force for a Date Range by Individual GA” may provide the total in-force premium for a specified GA number and is determined by paid-for dates that fall in the date range specified by the user. Reports regarding “Premium In-force for a Date Range by Office” may provide the total in-force premium by office and is determined by paid-for dates that fall in the date range specified by the user. Reports regarding “Premium In-force for a Date Range by Team ID” may provide the total in-force premium for a specified team identification and is determined by paid-for dates that fall in the date range specified by the user. Reports regarding “Premium In-force for a Date Range by Team Name” may provide the total in-force premium for a specified team name and is determined by paid-for dates that fall in the date range specified by the user.

According to an embodiment of the invention, reports regarding “Reissue Percent Counts for a Date Range by Channel” may provide a count of reissued policies, total policies mailed, and percentage of reissued policies for a specified date range. Percent may be determined by the total count mailed and the total count reissued. Counts may be based on the mail date. Reports regarding “Reissue Percent Counts for a Date Range by Individual GA” may provide a count of reissued policies, total policies mailed, and percentage of reissued policies for a specified date range. Percent may be determined by the total count mailed and the total count reissued. Counts may be based on the mail date. Reports regarding “Reissue Percent Counts for a Date Range by Office” may provide a count of reissued policies, total policies mailed, and percentage of reissued policies for a specified date range. Percent may be determined by the total count mailed and the total count reissued. Counts may be based on the mail date. Reports regarding “Reissue Percent Counts for a Date Range by Team Identification” may provide a count of reissued policies, total policies mailed, and percentage of reissued policies for a specified date range. Percent may be determined by the total count mailed and the total count reissued. Counts may be based on the mail date. Reports regarding “Reissue Percent Counts for a Date Range by Team Name” may provide a count of reissued policies, total policies mailed, and percentage of reissued policies for a specified date range. Percent may be determined by the total count mailed and the total count reissued. Counts may be based on the mail date. Reports regarding “Total Counts by Channel” may provide a count of cases that are submitted, paid-for, issued, not taken, cancelled, mailed, or declined within a certain date range specified by the user and for a channel specified by the user. The report may use the date field for each of these actions to take the counts.

According to an embodiment of the invention, reports regarding “Total Counts by Individual GA” may provide a count of cases that are submitted, paid-for, issued, not taken, cancelled, mailed, or declined within a certain date range specified by the user and for a GA number specified by the user. The report may use the date field for each of these actions to take the counts. Reports regarding “Total Counts by Office” may provide a count of cases, by office, that are submitted, paid-for, issued, not taken, cancelled, mailed, or declined within a certain date range specified by the user. The report may use the date field for each of these actions to take the counts. Reports regarding “Total Counts by Team ID” may provide a count of cases that are submitted, paid-for, issued, not taken, cancelled, mailed, or declined within a certain date range specified by the user and for a team identification specified by the user. The report may use the date field for each of these actions to take the counts. Reports regarding “Total Counts by Team Name” may provide a count of cases that are submitted, paid-for, issued, not taken, cancelled, mailed, or declined within a certain date range specified by the user and for a team name specified by the user. The report may use the date field for each of these actions to take the counts.

According to an embodiment of the invention, various terms used in reports may be given specific meanings or definitions. By way of example, “Application Date: may be the date the application is signed, “Application Received Date” may be the date the application is received, “Application Submit Date” may be the date the application is entered into a particular system, “Underwriter Approval Date” may be the date the underwriter approves the file, “Approved Ready for Issue Date” for an approved file, may be the date when all administrative requirements have been received, and “Issue Date” may be the date the issue transaction is completed on the system to produce a policy.

By way of other examples, “Policy Mail Date” may be the date the policy is mailed, “Inforce Date” may be the date the case is placed in-force on the system, “Requirement Order Date” may be the date the requirement is loaded on the system, “Requirement Receipt Date” may be the date the requirement is receipted on the system, “Number of Submitted Applications” may be the number of applications entered on the system based on the application submit date, and “Number of Trial Applications” where a trial is an informal request for underwriting decision without an application and the number of trials entered on the system based on the application submit date. By way of a further example, “Number of Issued Files” may be the number of files issued based on the issue date, “Number of Reissued Files,” for an issued file, may be an agent's request made to change or correct an error and produce a new policy, “Number of Pending Underwriting Files” may be the number of files pending underwriting applications which have not been approved or given any other final disposition, and “Number of In-force File” may be the number of files placed in-force on the system.

By way of another example, “Number of Canceled Files” may be the number of files canceled due to either agent's request or due to incomplete requirements received, “Number of Declined Files” may be the number of files which have been declined by the underwriter, “Number of NTO Files (Not Taken Out)” may be the number of files not taken after a policy has been mailed either by an agent request or the delivery requirements are not received within the delivery period, “Number of Pending Settlement Files” may be the number of files which have been issued but not placed in-force, awaiting delivery requirements, “Number of Reopened Files Re-open” may be a case which has been declined, canceled, or not taken which is requested to be reopened by the agent, and “Number of Days in Cycle Time” may be the number of calendar days between the designated start date and end date.

According to an embodiment of the invention, various decisions may be made. Business Cycle Time may include reissues due to errors made and companions, but not include trials, agent requested re-issues and re-opens. Re-issue and re-open cycle times and volumes may be able to be retrieved separately, and trial cycle times may be retrieved separately and may include different time measures based on customer VOC. Categories for the number of days pending underwriting and settlement may be in seven day increments along with a “greater than X days” selection. Details may be downloaded to a spreadsheet application (e.g., Excel) for user defined sorts. Detail reports may include totals. Reporting ability needed by rate class and table ratings may include the percentage of each class by GA. Clearer definitions may be needed from various financial reports. As further described above, various operational definitions may be used in connection with one or more embodiments of the present invention. By way of example,

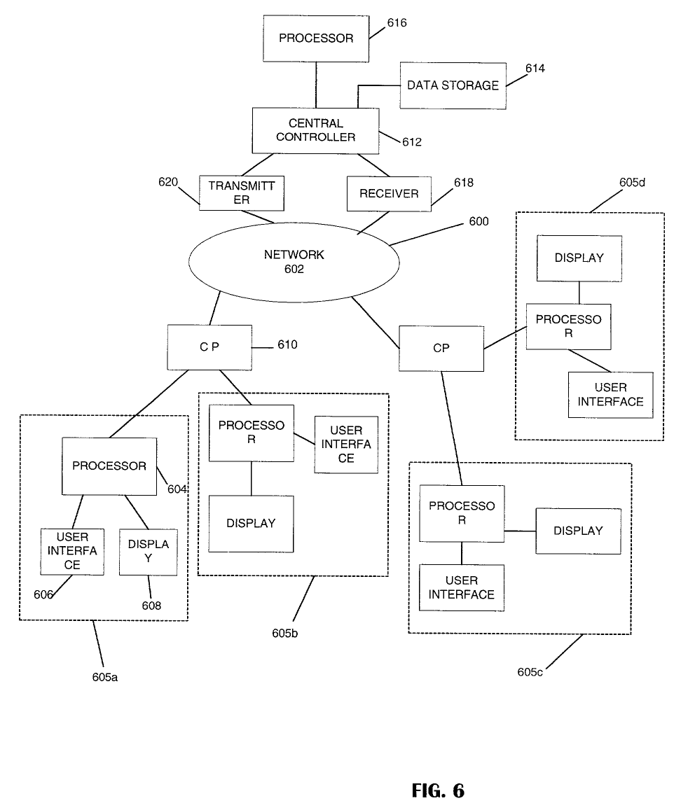

FIG. 6 illustrates a system 600 according to an embodiment of the present invention. The system 600 comprises multiple requester devices 605 (also referred to as “computers”) used by a plurality of requesters to connect to a network 602 through multiple connector providers (CPs) 610. The network 602 may be any network that permits multiple requesters or computers to connect and interact. According to an embodiment of the invention, the network 602 may be comprised of a dedicated line to connect the plurality of the requesters, such as the Internet, an intranet, a local area network (LAN), a wide area network (WAN), a wireless network, or other type of network. The CP 610 may be a provider that connects the requesters to the network 602. For example, the CP 610 may be an Internet service provider (ISP), a dial-up access means, such as a modem, or other manner of connecting to the network 602. In actual practice, there may be significantly more users connected to the system 600 than shown in FIG. 6. This would mean that there would be additional requesters which are connected through the same CPs shown or through another CP 600. Nevertheless, for purposes of illustration, the discussion will presume four requester devices 605 are connected to the network 602 through two CPs 610.

According to an embodiment of the invention, requester devices 605a-605d may each make use of any device (e.g., a computer, a wireless telephone, a personal digital assistant, etc.) capable of accessing the network 602 through the CP 610. Alternatively, some or all of the requester devices 605a-605d may access the Network 602 through a direct connection, such as a T1 line, or similar connection. FIG. 6 shows the four requester devices 605a-605d, each having a connection to the network 602 through a CP 610a and 610b. The Requester devices 605a-605d may each make use of a personal computer such as a computer located in the requester's home, or may use other devices which allow the requester to access and interact with others on the network 602. Central controller module 612 may also have a connection to the Network 602 as described above. The central controller module 612 may communicate with one or more data storage modules 614, the latter being discussed in more detail below.

Each of the requester devices 605a-605d used may contain a processor module 604, a display module 608, and the user interface module 606. Each of the requester devices 605a-605d may have at least one user interface module 606 for interacting and controlling the computer. The user interface module 606 may be comprised of one or more of a keyboard, a joystick, a touchpad, a mouse, a scanner or any similar device or combination of devices. Each of the computers 605a-605d used by requester devices 605a-605d may also include a display module 608, such as a CRT display or other device.

The system 600 further includes the central controller module 612. The central controller module 612 may maintain a connection to the network 602 such as through transmitter module 618 and a receiver module 620. The transmitter module 618 and the receiver module 620 may be comprised of conventional devices which enable the central controller module 612 to interact with the network 602. According to an embodiment of the invention, the transmitter module 618 and the receiver module 620 may be integral with the central controller module 612. The connection to the Network 602 by the central controller module 612 and computers 605 may be a high speed, large bandwidth connection, such as though a T1 or a T3 line, a cable connection, a telephone line connection, a DSL connection, or other type of connection. The central controller module 612 functions to permit the requester devices 605a-605d to interact with each other in connection with various applications, messaging services and other services which may be provided through the System 600.

The central controller module 612 preferably comprises either a single server computer or a plurality of multiple server computers configured to appear to the requester devices 605a-605d as a single resource. The central controller module 612 communicates with a number of data the storage modules 614. Each of the data storage modules 614 stores a plurality of digital files. According to an embodiment of the invention, any of the data storage modules 614 may be located on one or more data storage devices, where the data storage devices are combined or separate from the controller module 612.

While the system 600 of FIG. 6 discloses the requester device 605 connected to the network 602, it should be understood that a personal digital assistant (“PDA”), a mobile telephone, a television, or another device that permits access to the Network 802 may be used to arrive at the system of the present invention.

According to another embodiment of the invention, a computer-usable and writeable medium having a plurality of computer readable program code stored therein may be provided for practicing the process of the present invention. The process and system of the present invention may be implemented within a variety of operating systems, such as Windows(M, various versions of a Unix-based operating system (e.g., a Hewlett Packard, a Red Hat, or a Linux version of a Unix-based operating system), or various versions of an AS/400-based operating system. Other operating systems may also be used. For example, the computer-usable and writeable medium may be comprised of a CD ROM, a floppy disk, a hard disk, or any other computer-usable medium. One or more of the components of the system 600 may comprise computer readable program code in the form of functional instructions stored in the computer-usable medium such that when the computer-usable medium is installed on the system 600, those components cause the system 600 to perform the functions described. The computer readable program code for the present invention may also be bundled with other computer readable program software.

According to one embodiment, the central controller module 612, the data storage 614, the processor module 616, the receiver module 618, and the transmitter module 620 may comprise computer-readable code that, when installed on a computer, perform the functions described above. Also, only some of the components may be provided in computer-readable code.

Additionally, various entities and combinations of entities may employ a computer to implement the components performing the above described functions. According to an embodiment of the invention, the computer may be a standard computer comprising an input device, an output device, a processor device, and data storage device. According to other embodiments of the invention, various components may be different department computers within the same corporation or entity. Other computer configurations may also be used. According to another embodiment of the invention, various components may be separate entities such as corporations or limited liability companies. Other embodiments, in compliance with applicable laws and regulations, may also be used.

According to one specific embodiment of the present invention, a system may comprise components of a software system. The system may operate on a network and may be connected to other systems sharing a common database. Other hardware arrangements may also be provided.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed is:

1. A process for generating reports related to new business production at a plurality of production sources located geographically apart from each other, the process comprising the steps of:
receiving a request to generate at least one report related to new business production for at least one of the plurality of production sources;
receiving at least one selection parameter related to the at least one requested report, where the at least one selection parameter defines a portion of the information to be contained within the at least one report, and where the information has been received from the plurality of production sources;
processing the at least one selection parameter, where the processing includes obtaining the portion of the information and formatting the at least one report; and
generating the at least one report based on the processed selection parameters.

2. The process according to claim 1, wherein the new business production relates to new business production of insurance products.

3. The process according to claim 2, where the plurality of production sources comprise at least one of:
a) an insurance agent;
b) an insurance agency;
c) a financial service agent; and
d) a financial service agency.

4. The process according to claim 1, wherein the step of formatting the at least one report further comprises arranging contents of the report into an appropriate presentation format.

5. The process according to claim 1, wherein the step of processing further comprises converting the report into one or more application formats for viewing.

6. The process according to claim 1, where the information received from the plurality of production sources relates to a plurality of insurance products and where information about at least one of the plurality of insurance products includes information in a different format than information about at least one other of the plurality of insurance products.

7. The process according to claim 6, where the report contains information related to the plurality of insurance products.

8. The process according to claim 7, where the report further contains information related to the plurality of productions sources.

9. The process according to claim 8, wherein the information received from the plurality of production sources relates is about the production sources and where information about at least one of the plurality of production sources includes information in a different format than information about at least one other of the plurality of production sources.

10. The process according to claim 7, wherein the information received from the plurality of production sources relates is about the production sources and where information about at least one of the plurality of production sources includes information in a different format than information about at least one other of the plurality of production sources.

11. The process according to claim 6, where the report further contains information related to the plurality of productions sources.

12. The process according to claim 11, wherein the information received from the plurality of production sources relates is about the production sources and where information about at least one of the plurality of production sources includes information in a different format than information about at least one other of the plurality of production sources.

13. The process according to claim 1, wherein the information received from the plurality of production sources relates is about the production sources and where information about at least one of the plurality of production sources includes information in a different format than information about at least one other of the plurality of production sources.

14. The process according to claim 13, where the report contains information related to the plurality of insurance products.

15. The process according to claim 14, where the report further contains information related to the plurality of productions sources.

16. The process according to claim 13, where the report further contains information related to the plurality of productions sources.

17. A process for generating reports related to new business production of insurance products at a plurality of production sources located geographically apart from each other, the process comprising the steps of:
receiving a request to generate at least one report related to new business production for at least one of the plurality of production sources;
receiving at least one selection parameter related to the at least one requested report, where the at least one selection parameter defines a portion of the information to be contained within the at least one report, and where the information has been received from the plurality of production sources;
processing the at least one selection parameter, where processing includes:
a) obtaining the portion of the information;
b) formatting the at least one report, including arranging contents of the report into an appropriate presentation format; and
c) converting the report into one or more application formats for viewing; and
generating the at least one report based on the processed selection parameters.

18. The process according to claim 17, where the plurality of production sources comprise at least one of:
a) an insurance agent;
b) an insurance agency;
c) a financial service agent; and
d) a financial service agency.

19. A system for generating reports related to new business production at a plurality of production sources located geographically apart from each other, the system comprising:
means for receiving a request to generate at least one report related to new business production for at least one of the plurality of production sources;
means for receiving at least one selection parameter related to the at least one requested report, where the at least one selection parameter defines a portion of the information to be contained within the at least one report, and where the information has been received from the plurality of production sources;
means for processing the at least one selection parameter, where the processing includes obtaining the portion of the information and formatting the at least one report; and
means for generating the at least one report based on the processed selection parameters.

20. The system according to claim 19, wherein the new business production relates to new business production of insurance products.

21. The system according to claim 20, where the plurality of production sources comprise at least one of:
a) an insurance agent;
b) an insurance agency;
c) a financial service agent; and
d) a financial service agency.

22. The system according to claim 19, wherein formatting the at least one report further comprises arranging contents of the report into an appropriate presentation format.

23. The system according to claim 19, wherein the step of processing further comprises means for converting the report into one or more application formats for viewing.

24. The system according to claim 19, where the information received from the plurality of production sources relates to a plurality of insurance products and where information about at least one of the plurality of insurance products includes information in a different format than information about at least one other of the plurality of insurance products.

25. The system according to claim 24, where the report contains information related to the plurality of insurance products.

26. The system according to claim 25, where the report further contains information related to the plurality of productions sources.

27. The system according to claim 26, wherein the information received from the plurality of production sources relates is about the production sources and where information about at least one of the plurality of production sources includes information in a different format than information about at least one other of the plurality of production sources.

28. The system according to claim 25, wherein the information received from the plurality of production sources relates is about the production sources and where information about at least one of the plurality of production sources includes information in a different format than information about at least one other of the plurality of production sources.

29. The system according to claim 24, where the report further contains information related to the plurality of productions sources.

30. The system according to claim 29, wherein the information received from the plurality of production sources relates is about the production sources and where information about at least one of the plurality of production sources includes information in a different format than information about at least one other of the plurality of production sources.

31. The system according to claim 19, wherein the information received from the plurality of production sources relates is about the production sources and where information about at least one of the plurality of production sources includes information in a different format than information about at least one other of the plurality of production sources.

32. The system according to claim 31, where the report contains information related to the plurality of insurance products.

33. The system according to claim 32, where the report further contains information related to the plurality of productions sources.

34. The system according to claim 31, where the report further contains information related to the plurality of productions sources.

35. A system for generating reports related to new business production of insurance products at a plurality of production sources located geographically apart from each other, the system comprising:
means for receiving a request to generate at least one report related to new business production for at least one of the plurality of production sources;
means for receiving at least one selection parameter related to the at least one requested report, where the at least one selection parameter defines a portion of the information to be contained within the at least one report, and where the information has been received from the plurality of production sources;
means for processing the at least one selection parameter, where processing includes:
a) obtaining the portion of the information;
b) formatting the at least one report, including arranging contents of the report into an appropriate presentation format; and
c) converting the report into one or more application formats for viewing; and
means for generating the at least one report based on the processed selection parameters.

36. The system according to claim 35, where the plurality of production sources comprise at least one of:
a) an insurance agent;
b) an insurance agency;
c) a financial service agent; and
d) a financial service agency.

37. A medium storing code for causing a processor to process generate reports related to new business production at a plurality of production sources located geographically apart from each other, the medium comprising:
code for causing a processor to receive a request to generate at least one report related to new business production for at least one of the plurality of production sources;
code for causing a processor to receive at least one selection parameter related to the at least one requested report, where the at least one selection parameter defines a portion of the information to be contained within the at least one report, and where the information has been received from the plurality of production sources;
code for causing a processor to process the at least one selection parameter, where the processing includes obtaining the portion of the information and formatting the at least one report; and
code for causing a processor to generate the at least one report based on the processed selection parameters.

38. The medium according to claim 37, wherein the new business production relates to new business production of insurance products.

39. The medium according to claim 38, where the plurality of production sources comprise at least one of:
a) an insurance agent;
b) an insurance agency;
c) a financial service agent; and
d) a financial service agency.

40. The medium according to claim 37, wherein the step of formatting the at least one report further comprises arranging contents of the report into an appropriate presentation format.

41. The medium according to claim 37, wherein the step of processing further comprises the converting the report into one or more application formats for viewing.

42. The medium according to claim 37, where the information received from the plurality of production sources relates to a plurality of insurance products and where information about at least one of the plurality of insurance products includes information in a different format than information about at least one other of the plurality of insurance products.

43. The medium according to claim 42, where the report contains information related to the plurality of insurance products.

44. The medium according to claim 43, where the report further contains information related to the plurality of productions sources.

45. The medium according to claim 44, wherein the information received from the plurality of production sources relates is about the production sources and where information about at least one of the plurality of production sources includes information in a different format than information about at least one other of the plurality of production sources.

46. The medium according to claim 43, wherein the information received from the plurality of production sources relates is about the production sources and where information about at least one of the plurality of production sources includes information in a different format than information about at least one other of the plurality of production sources.

47. The medium according to claim 43, where the report further contains information related to the plurality of productions sources.

48. The medium according to claim 47, wherein the information received from the plurality of production sources relates is about the production sources and where information about at least one of the plurality of production sources includes information in a different format than information about at least one other of the plurality of production sources.

49. The medium according to claim 37, wherein the information received from the plurality of production sources relates is about the production sources and where information about at least one of the plurality of production sources includes information in a different format than information about at least one other of the plurality of production sources.

50. The medium according to claim 49, where the report contains information related to the plurality of insurance products.

51. The medium according to claim 50, where the report further contains information related to the plurality of productions sources.

52. The medium according to claim 49, where the report further contains information related to the plurality of productions sources.

53. A medium storing code for causing a processor to generate reports related to new business production of insurance products at a plurality of production sources located geographically apart from each other, the medium comprising:
code for causing a processor to receive a request to generate at least one report related to new business production for at least one of the plurality of production sources;
code for causing a processor to receive at least one selection parameter related to the at least one requested report, where the at least one selection parameter defines a portion of the information to be contained within the at least one report, and where the information has been received from the plurality of production sources;
code for causing a processor to process the at least one selection parameter, where processing includes:
a) obtaining the portion of the information;
b) formatting the at least one report, including arranging contents of the report into an appropriate presentation format; and
c) converting the report into one or more application formats for viewing; and
code for causing a processor to generate the at least one report based on the processed selection parameters.

54. The medium according to claim 53, where the plurality of production sources comprise at least one of:
a) an insurance agent;
b) an insurance agency;
c) a financial service agent; and
d) a financial service agency.
